(19) United States
(12) Patent Application Publication
(10) Pub. No.: US 2024/0045950 A1
(43) Pub. Date: Feb. 8, 2024

(54) SYSTEMS AND METHODS FOR ASSESSING CYBERSECURITY EFFICACY OF ENTITIES AGAINST COMMON CONTROL AND MATURITY FRAMEWORKS USING EXTERNALLY-OBSERVED DATASETS

(71) Applicant: BitSight Technologies, Inc., Boston, MA (US)

(72) Inventors: Tiago Bagulho Monteiro Pereira, Lisbon (PT); Daniel Dahlberg, Somerville, MA (US)

(21) Appl. No.: 18/359,183

(22) Filed: Jul. 26, 2023

Related U.S. Application Data
(60) Provisional application No. 63/392,179, filed on Jul. 26, 2022.

(51) Int. Cl. G06F 21/55

(52) U.S. Cl. CPC G06F 21/552; G06F 2221/034

(57) ABSTRACT

Systems and methods are disclosed for determining control insights corresponding to an entity based on configurable rules. Event datasets corresponding to a plurality of cybersecurity events associated with an entity during a first time period are received. The event datasets are enriched with a plurality of indicators mapped to the plurality of cybersecurity based on a respective event type corresponding to each of the plurality of cybersecurity events. Control insights corresponding to the entity are determined based on a comparison of the one or more enriched event datasets and a plurality of rules. At least one rule is defined by (i) a rule type and (ii) a first subset of the plurality of indicators that is provided as an input to the at least one rule. The control insights each provide an indication of a state of a respective cybersecurity control mechanism corresponding to the entity.

### CROSS-REFERENCE TO RELATED APPLICATION(S)

This application claims the benefit of and priority to U.S. Provisional Application No. 63/392,179, filed on Jul. 26, 2022, entitled “SYSTEMS AND METHODS FOR ASSESSING CYBERSECURITY EFFICACY OF ENTITIES AGAINST COMMON CONTROL AND MATURITY FRAMEWORKS USING EXTERNALLY-OBSERVED DATASETS,” which is hereby incorporated by reference herein in its entirety.

### TECHNICAL FIELD

The following disclosure is directed to methods and systems for assessing the cybersecurity state of entities, more specifically, methods and systems for assessing the cybersecurity efficacy of entities against common control and maturity frameworks using externally-observed datasets.

### BACKGROUND

Presently, a cybersecurity state of an entity (e.g., individual, business owner, service provider, organization, etc.) can be evaluated and monitored based on one or more data indicative of the entity's cybersecurity state. Such data may be publicly and/or externally available, such that internal data corresponding to the entity is not required to evaluate the entity's cybersecurity state. In some cases, evaluation of an entity's cybersecurity state can include an evaluation of specific cybersecurity configuration, vulnerability presence, malware presence, and/or other measurement points in an entity's computing system(s) (e.g., computing system(s) associated with an entity). However, entities may wish to evaluate outcomes and other higher level results corresponding to their cybersecurity state in addition to and/or in place of categorical evaluations of individual components of their cybersecurity state.

### SUMMARY

In various aspects, embodiments of the invention feature a computer-implemented method and supporting systems. In one aspect, the subject matter described herein relates to a computer-implemented method for determining one or more control insights corresponding to an entity. The method can include receiving one or more event datasets corresponding to a plurality of cybersecurity events associated with an entity during a first time period. The method can include enriching, based on a respective event type corresponding to each of the plurality of cybersecurity events, the one or more event datasets with a plurality of indicators mapped to the plurality of cybersecurity events. The method can include determining, based on a comparison of the one or more enriched event datasets and a plurality of rules, the one or more control insights corresponding to the entity, wherein each of the one or more control insights provides an indication of a state of a respective cybersecurity control mechanism corresponding to the entity, wherein at least one rule of the plurality of rules is defined by (i) a rule type and (ii) a first subset of the plurality of indicators that is provided as an input to the at least one rule.

Various embodiments of the method can include one or more of the following features.

The plurality of cybersecurity events can be associated with one or more computing systems corresponding to the entity. The plurality of cybersecurity events can be derived from one or more of: malware sinkhole data, honeypot data, port scanning data, vulnerability scanning data, service configuration scanning data, actively and/or passively collected domain name system (DNS) data, advertising and marketing telemetry data, application-based endpoint behavior data, mobile application security assessment result data, domain name system (DNS) log data, authentication log data, netflow log data, web proxy log data, and firewall log data. The method can further include determining a plurality of event types for the plurality of cybersecurity events, wherein each cybersecurity event is mapped to a respective event type of the plurality of event types that identifies the cybersecurity event. Each cybersecurity event can be mapped to a respective subset of the plurality of indicators comprising contextual information for the cybersecurity event. The enriching the one or more event datasets with the plurality of indicators can further include receiving a user input comprising a selection of a second subset of the plurality of indicators corresponding to at least one cybersecurity event of the plurality of cybersecurity events; and enriching the at least one cybersecurity event with the second subset of the plurality of indicators.

In some variations, at least one control insight of the one or more control insights includes (i) a natural language description of the state of the respective cybersecurity control mechanism, and (ii) a positive, neutral, or negative assessment of the state of the respective cybersecurity control mechanism. The least one control insight may be based on a control framework selected from the group consisting of: a Center for Internet Security Top 20 Critical Security Controls (CIS20) framework, a National Institute of Standards and Technology (NIST) framework, and an International Organization for Standardization and International Electrotechnical Commission (ISO/IEC) 27001 framework. The at least one rule of the plurality of rules can be further defined based on at least one characteristic corresponding to the entity and by (i) the rule type, (ii) the first subset of the plurality of indicators, and (iii) at least one threshold value. The plurality of rules can include a plurality of conditional statements. The determining the one or more control insights corresponding to the entity can further include: comparing the plurality of indicators of the one or more enriched event datasets to the plurality of rules; determining, based on the comparison of the plurality of indicators to the plurality of rules, the first subset of the plurality of indicators satisfying the at least one rule of the plurality of rules; and deriving, based on the first subset of the plurality of indicators satisfying the at least one rule, at least one control insight of the one or more control insights that is mapped to the at least one rule. In some variations, the at least one rule is further defined by at least one threshold value. The method can further include determining one or more values from the first subset of the plurality of indicators; comparing, based on the rule type of the at least one rule, the one or more values to the at least one threshold value; and determining, based on the comparison of the one or more values to the at least one threshold value, the plurality of indicators satisfies the rule to derive the at least one control insight.

In some variations, the method can further include receiving a user input comprising a selection of the type and the subset of the indicators for the at least one rule of the plurality of rules. Each of the plurality of cybersecurity events comprises a respective timestamp indicative of a time at which the cybersecurity event was observed. The method can further include filtering, based on the timestamps of the plurality of cybersecurity events, the one or more event datasets by removing, from the one or more event datasets, a subset of the plurality of cybersecurity events comprising timestamps that are external to the first time period. The one or more control insights can include two or more control insights, wherein the two or more control insights provide respective indications of the state of the same cybersecurity control mechanism. The method can further include determining, by an evaluation model and based on the two or more control insights, a perception of the cybersecurity control mechanism. The method can further include generating for display, based on the one or more control insights, an action that when executed by the entity is configured to improve a state of at least one of the cybersecurity control mechanisms, wherein the action is determined based on a control framework corresponding to the at least one of the cybersecurity control mechanisms.

Other aspects of the invention comprise systems implemented in various combinations of computing hardware and software to achieve the methods described herein.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 depicts a block diagram of a control insights system, according to some embodiments;

FIG. 2 depicts a flowchart of an exemplary method for determining control insights corresponding to an entity, according to some embodiments; and

FIG. 3 is a block diagram of an example computer system that may be used in implementing the technology described herein.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

The present disclosure is directed to methods and systems for assessing the cybersecurity state of entities, more specifically, methods and systems for assessing the cybersecurity efficacy of entities against common control and maturity frameworks using externally-observed datasets. Assessing the cybersecurity efficacy of entities can include generation of control insights relating to performance of individual cybersecurity controls as described herein.

In some embodiments, “cybersecurity controls” may refer to one or more cybersecurity control mechanisms that are applied to and/or used by an entity's computing system(s). Systems and methods as described herein may generate an indication of the effectiveness of an entity's cybersecurity controls, which may be referred to hereinafter as a “cybersecurity state” of the entity. The cybersecurity state of the entity may be optionally associated with (e.g., compared to) one or more frameworks (e.g., externally established frameworks). The systems and methods described herein may generate an indication of cybersecurity state of the entity using one or more data sources. Each data source may provide and/or indicate cybersecurity-related state information (e.g., data) corresponding to the entity. One or more (e.g., two) levels of abstraction can be used to determine insights relating to performance of individual cybersecurity controls, which may be referred to herein as “cybersecurity control insights” and/or “control insights”. Such control insights may be used, for example, by an entity's stakeholders to drive operational and cybersecurity business decisions associated with the entity.

In some embodiments, an entity that implements the systems and methods described herein to determine a cybersecurity state of a plurality of entities may be referred to as a “service provider”. The service provider may receive cybersecurity data for a plurality of entities (e.g., customer entities) from one or more data sources. Based on the received cybersecurity data, the service provider may generate and provide cybersecurity control insights and/or an indication of an entity's cybersecurity state to a respective entity. The generated results from the service provider may be made available to entities via a user interface (e.g., internet accessible user interface), a report, third-party computing systems (e.g., governance, risk and compliance (GRC) computing products), and/or any other suitable mechanism that enables individuals corresponding to entity to receive such results. Entities that receive cybersecurity control insights and/or an indication of their respective cybersecurity state from a service provider (e.g., via a control insights system) may be referred to as “customer entities”.

In some embodiments, the systems and methods described herein may include one or more use cases. Some non-limiting examples of use cases for the systems and methods can include (1) an entity wishes to obtain the service provider's external perception of the entity's cyber security controls; (2) an entity wishes to obtain the service provider's external perception of cybersecurity controls of a third-party entity different from the entity; and (3) an entity wishes to communicate the state of their cybersecurity controls to third-party entities and/or to individuals (e.g., a chief information security officer) and/or groups (e.g., a board of directors) corresponding to the entity.

In some embodiments, the systems and methods described herein may provide a qualitative assessment of individual cybersecurity controls corresponding to an entity. For example, a positive, neutral, or negative perception of an individual cybersecurity control may be provided by the systems and methods described herein. The qualitative assessment may be generated based on a control framework as described herein.

In some embodiments, the control insights described herein can provide an indication of an entity's higher level security practices (e.g., relating to individuals, cybersecurity processes, and cybersecurity technologies). The control insights can each be mapped to individual cybersecurity controls to provide a perception of the individual control's performance.

In some embodiments, the control insights may be generated based on one or more datasets. The one or more datasets may be derived from one or more data sources, where the one or more datasets are processed based on a set of rules. The set of rules may be defined by a plurality of individuals (e.g., cybersecurity experts) that are familiar with the details and limitations of each data source corresponding to the one or more datasets and the particular cyber security events indicated by the one or more datasets. In some cases, each of the one or more datasets may be associated with one or more “cybersecurity events” (also referred to herein as “events”), where at least some of the data included in the respective dataset was measured and/or otherwise observed during the event.

In some embodiments, the control insights can be used (e.g., by entity stakeholders) to adjust or maintain cybersecurity practices defined by individuals, cybersecurity processes, and/or cybersecurity technologies. Detection of particular cybersecurity systems and cybersecurity events (e.g., as indicated by the one or more datasets) may contribute to a qualitative assessment of individual cybersecurity controls. Detection of one or more predetermined cybersecurity systems and/or cybersecurity events may not be required for generation of a control insight corresponding to an individual cybersecurity control. For example, a threshold number of malware-infected computers associated with an entity may not be required to generate an individual control insight. In some cases, control insights can be mapped to one or more actions that an individual and/or entity can take that are configured to improve a state of the cybersecurity control(s) corresponding to a respective control insight.

In some embodiments, control insights may enable communication between entities or groups (e.g., business units) within an entity, where the communication is focused on the perception of a state of cybersecurity control performance for the entity or groups within the entity. An entity or group within an entity can provide a third-party entity evidence of its cybersecurity control practice.

In some embodiments, control insights may enable adjustment (e.g., fixing, remediation, etc.) of cybersecurity controls of an entity. In some cases, a control insight may be overridden based on verification of the performance of the cybersecurity control corresponding to the control insight. Use of control insights can provide a broader, more comprehensive indication of an entity's cybersecurity posture relative to data corresponding to individual cybersecurity metrics. Accordingly, control insights can reduce effort (e.g., time and cost) needed to remedy cybersecurity threats that do not materially contribute to performance of cybersecurity controls.

### Background for Control Insights

In some embodiments, a “cybersecurity control” may refer to abstraction for the individuals, cybersecurity processes, and/or cybersecurity technologies that are required to prevent or otherwise mitigate the risk of a threat or group of threats affecting an entity (e.g., via an entity's computing systems). A cybersecurity threat may affect an entity's computing systems and/or another third party entity's computing systems, where the entity has a relationship with the third-party entity (referred to as the entity's “affiliate”). In some cases, a cybersecurity control may correspond to an individual cybersecurity problem and/or risk area. Cybersecurity controls can be defined by a known framework (e.g., Center for Internet Security Top 20 Critical Security Controls (CIS20), National Institute of Standards and Technology (NIST), International Organization for Standardization and International Electrotechnical Commission (ISO/IEC) 27001), by an industry specific organization, and/or by the entity using the cybersecurity controls.

In some embodiments, a “safeguard”, “cybersecurity action”, and “cybersecurity recommendation” may each refer to a cybersecurity practice of a lower level than a cybersecurity control and may each correspond to actions required to validate (e.g., ensure) an efficacy of a particular cybersecurity control and/or improve a state of a particular cybersecurity control. As described herein, control insights may be mapped to one or more respective recommendations. In some cases, recommendations may be based on (e.g., a function of) a control framework for a particular cybersecurity control, such that the control framework provides the recommendation mapped to a particular cybersecurity control and control insight, where the recommendation includes at least one action that can be performed and/or applied by an entity to improve a state of the particular cybersecurity control.

In some embodiments, a “perception” may refer to a perception of a cybersecurity practice. The systems and methods described herein may produce perceptions of cybersecurity controls (e.g., based on one or more control insights). In some cases, a perception may not be a verified and/or evidence-based truth. Because a perception can be obtained by extrapolation from one or more generated control insights, where the control insights are derived from one or more datasets as described herein, the perception may be subject to possible error resulting from the extrapolation.

In some embodiments, “control insights” and “cybersecurity control insights” as described herein may refer one or more descriptions (e.g., natural language sentences) corresponding to a qualitative assessment (e.g., positive, negative, neutral, etc.) of cybersecurity practices of an entity. Each control insight is mapped to a particular cybersecurity control and to one or more safeguards, actions, and/or recommendations that can be applied to the cybersecurity practices of the entity, such that application of the safeguards, actions, and/or recommendations are configured to result in an improved assessment of the cybersecurity control. Control insights are determined as applicable to an entity based on one or more rules (e.g., conditional statements) that process one or more datasets corresponding to the entity. Control insights may be evidence-based, assumed to be true, and can be subject to less doubt than perceptions as described herein.

In some embodiments, an “indicator” may be mapped to data of the one or more datasets. Indicators can be mapped to each applicable type of observation (e.g., event) in the one or more datasets and can enrich the one or more datasets with contextual knowledge that the datasets represent. Indicators may be tags and/or metadata that are attributed to each event indicated by the one or more datasets, where the indicators represent what the event is describing and/or indicating. In some cases, indicators may be the same as or separate from event types and event subtypes described herein.

In some embodiments, a “rule” may be a logical condition that is required to be verified based on data from the one or more datasets for a particular control insight to be derived. Rules can include one or more logic (e.g., conditional logic embodied as computer code) and can be tested when processing the one or more datasets. Processing of the one or more datasets according to a rule can result in a condition of true (e.g., indicating the control insight is applicable to the processed data) or false (e.g., indicating the control insight is not applicable to the processed data). In some cases, one or more rules may trigger a particular control insight, such that a respective rule being true for particular data included in the one or more datasets causes the control insight to be representative of the particular data of the one or more datasets. A control insight can express a positive sentiment, a negative sentiment, or a neutral sentiment for a cybersecurity control corresponding to an entity, which may be independent of the logical conditions for the one or more datasets to correspond to (e.g., satisfy, trigger, meet) a rule. In some cases, a rule may be defined based on (i) a rule type, (ii) the indicator(s) that is/are provided as inputs to the rule, and/or (iii) one or more numeric fields (e.g., corresponding to threshold values on which the conditional logic of the rule is based). In some cases, a rule may be applicable to a particular entity based on data (e.g., indicators provided as inputs to the rule) included in the one or more datasets being observed within a particular time period.

### System Architecture

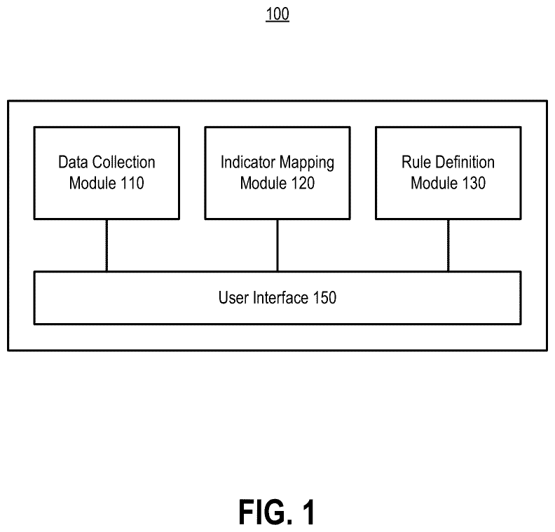

In some embodiments, a control insights system may execute the one or more of the methods described herein, where the control insights system comprises a computing system of one or more computing devices and/or networks. The control insights system may include one or more modules including a data collection module, an indicator mapping module, and a rule definition module. Referring to FIG. 1, an exemplary embodiment of a control insights system 100 is shown. In some embodiments, the cybersecurity modeling tool 100 may include a data collection module 110, an indicator mapping module 120, a rule definition module 130, and a user interface 150. The data collection module 110 may obtain dataset(s) of cyber event incidents from one or more computing systems communicatively connected to the cybersecurity modeling tool 100.

In some embodiments, a data collection module 110 may aggregate and/or otherwise receive one or more datasets. In some cases, the one or more datasets may include externally obtained (e.g., Internet-wide) data for a plurality of entities. In some cases, the one or more datasets may include internal data provided by an entity (e.g., to the service provider and the control insights system 100). In some cases, the data included in the one or more datasets can be collected using various cybersecurity monitoring systems as described in U.S. patent application Ser. No. 13/240,572 filed on Sep. 22, 2011, U.S. patent application Ser. No. 14/944,484 filed on Nov. 18, 2015, U.S. patent application Ser. No. 15/142,677 filed on Apr. 29, 2016, U.S. patent application Ser. No. 16/514,771 filed on Jul. 17, 2019, U.S. patent application Ser. No. 16/802,232 filed on Feb. 26, 2020, and U.S. patent application Ser. No. 17/945,337 filed on Sep. 15, 2022, each of which are incorporated herein by reference in their entireties.

In some embodiments, the data collection module 110 may receive (e.g., ingest, obtain, aggregate, etc.) internal data and external data to produce a report (e.g., including one or more control insights and perceptions) that is agnostic of the data's origin. In some cases, the received data may include contextual information (e.g., as metadata) indicating an origin of the data. If the received data includes contextual information, the received data's specific origin may be retained throughout the processing and transformation of the received data into one or more indicators and control insights.

In some embodiments, the data collection module 110 may receive (e.g., obtain) the one or more datasets from a plurality of data sources. Some non-limiting examples of external (e.g., internet-wide, externally obtained) data received by the data collection module 110 and included in the one or more datasets can include: malware sinkhole data, honeypot data, port scanning data, vulnerability scanning data, service configuration scanning data, actively and passively collected Domain Name System (DNS) data, advertising and marketing telemetry data, application-based endpoint behavior data, and mobile application security assessment data. Some non-limiting examples of internal (e.g., entity-provided) data received by the data collection module 110 and included in the one or more datasets can include: DNS logs, authentication logs, netflow logs, web proxy logs, and firewall logs. In some cases, data received by the data collection module 110 and included in the one or more datasets can include: malware emulator data, plaintext and dark web crawling data, file sharing protocol use data, deprecated software and hardware platform data, DNS blacklist (DNSBL) data, spam data, software installation log and reporting data, malware sandboxing data, and phishing analysis and evaluation data.

In some embodiments, the one or more datasets received by the data collection module 110 can include any data that originates from or is destined to the entity's computing network infrastructure or that is otherwise related to the entity's individuals, processes, and/or technologies. Data sources of the one or more datasets aggregated by the data collection module 110 may not be required to be the same for different entities as the objective of the control insights system 100 may not be a comparative analysis or a score calculation. In other words, externally-originated data that exhibits a particular bias towards a subset of entities in its coverage (e.g., by geography) is suitable for the control insights system 100.

As described herein, the one or more datasets aggregated by the data collection module 110 may be derived from diverse data sources, such as externally-originated data collected by the service provider, externally-originated data collected by third-party entities and provided to the service provider, and/or internal data provided to the service provider (e.g., by the entity). Based on the different data sources, the one or more datasets may be processed and normalized by the control insights system 100 before being manipulated and transformed by downstream functions of the system. An indicator mapping module 120 may receive the one or more datasets aggregated by the data collection module 110 and may perform processing and/or normalization processes on the one or more datasets. The processing and/or normalization of the one or more datasets may enable transformation of the one or more datasets into a plurality of indicators that can be provided as inputs to one or more rules to determine control insights corresponding to an entity.

In some embodiments, the indicator mapping module 120 of the control insights system 100 may enrich the one or more datasets with descriptive categories and subcategories (referred to as types and subtypes), that summarize the event(s) included in the dataset(s). For example, the indicator mapping module 120 may transform an event and associated metadata produced by an infected Conficker system to a service provider sinkhole as:
type/category: “Malware”
subtype/subcategory: “Worm”
value/further type or category: “Conficker”

In some embodiments, the indicator mapping module 120 can enrich the one or more datasets with types and subtypes for each event indicated by the one or more datasets prior to mapping the one or more datasets to indicators as described herein. In some cases, the indicator mapping module 120 may not enrich the one or more datasets with types and subtypes for each event indicated by the one or more datasets, such that the one or more datasets are mapped to indicators without added event type and subtype information.

In some embodiments, normalization of the one or more datasets may serve to identify event types and subtypes of the events included in the one or more datasets. In some cases, normalization of the one or more datasets may enable hierarchical organization (e.g., by event type) of the events included in the one or more datasets. Based on the mapped event types and subtype for the event included in the one or more datasets, the indicator mapping module 120 may map the events of the one or more datasets to a set of indicators that add contextual knowledge for each event. The added indicators may enable the control insights system 100 to process the one or more datasets with finer granularity compared to the one or more datasets before the mapping, as the indicators can be provide additional contextual information for events that can provided as an input to the rules as described herein

In some embodiments, the indicator mapping module 120 may receive the one or more datasets from the data collection module 110. Based on receiving the one or more datasets, the indicator mapping module 120 may process the one or more datasets by mapping each event of the one or more datasets to indicator(s) corresponding to the event type and subtype of the respective event. In some cases, an event included in the one or more datasets may include one or more existing indicators that are further enriched or not enriched by the indicator mapping module 120. A mapping of indicator(s) to event types and/or subtypes of events included in the one or more datasets may be predetermined. For example, an observation of Conficker in a system that is indicated by the one or more datasets may have a predetermined mapping to the event type and subtype of “Malware” and “Worm”, respectively. Predetermined mappings of event types and/or subtypes to particular indicators (e.g., that may correspond to the events included in the one or more datasets) may be stored by and/or accessible by the control insights system 100 As an example, the predetermined mappings of event types and/or subtypes to indicators may be stored in a lookup table (or any other suitable data storage structure) accessible by the control insights system 100. The predetermined mappings of event types and subtypes of events to indicators may be selected based on quantitative and/or qualitative characteristics of the data indicative of the respective events. In some cases, the predetermined mappings may be based on one or more control frameworks as described herein.

In some embodiments, individuals (e.g., cybersecurity experts) having knowledge of each data source and event type of events included in the one or more datasets can provide their knowledge to the control insights system 100 (e.g., by the user interface 150 as described herein). Addition of the individuals' knowledge to the indicator mapping process may increase the available information that can be used to obtain control insights, which can lead to higher quality and/or more relevant control insights. Via a user interface 150, a user may add one or more indicators corresponding to a particular event type and/or subtype, such that the added indicators can be mapped to a particular event by the indicator mapping module 120 based on the event type and/or subtype corresponding to the event. As an example, an individual providing knowledge to the control insights system 100 can extrapolate and add a number of indicators from their knowledge of an event for use by the control insights system 100. In this case, the individual could provide the following indicators for an observed event corresponding to an infected Conficker system:
Infection (considering Conficker is a piece of malware)
Desktop computer (considering Conficker affects a desktop operating system)
Operating system version (based on the operating systems that were targeted by the malware)
Worm (as Conficker is considered a worm)
Defunct Malware (considering the malware family no longer directly poses a risk to entities due to its age)

In some embodiments, the indicator mapping module 120 unifies data of the one or more datasets from disparate data sources based on the addition of the indicator abstractions. In some cases, the same indicator may be sourced from many types of events, many different data sources, and many different data collection methods. The addition of indicators to the events included in the one or more datasets may allow for derivation of control insights from disparate data sources using common rules that receive the indicators as an input.

In some embodiments, a rule definition module 130 can receive one or more processed datasets (also referred to as “enriched datasets”) from the indicator mapping module 120. The processed datasets may include event types, event subtypes, and/or indicators in addition to the data of the original datasets aggregated by the data collection module 110. In some cases, the rule definition module 130 may include and/or access a plurality of rules as described herein. The rule definition module 130 may assess each control insight's applicability to the one or more processed datasets. The rule definition module 130 may assess each control insights applicability to the one or more processed datasets based on processing all of the indicators (e.g., as derived from events) in an evaluation time period according to the plurality of rules. If a particular rule's condition is verified (e.g., satisfied) for data of the processed datasets, the rule definition module 130 may map a control insight corresponding to the rule to the entity associated with the data that satisfies the rule's condition. Additionally or alternatively, if a particular rule's condition is not verified (e.g., satisfied) for data of the processed datasets, the rule definition module 130 may map a second control insight corresponding to the rule to the entity associated with the data that satisfies the rule's condition. The use of rules to process events observed and/or otherwise corresponding to a time period (e.g., as indicated by the one or more processed datasets) for a given entity can enable evaluation of data from disparate sources. Evaluation of the data in the context of individual rules can lead to a more complex and valuable control insight.

In some embodiments, as described herein, rules of the rule definition module 130 can be mapped to control insight(s). The rule(s) that are mapped to each control insight can defined by (i) a rule type, (ii) one or more indicators provided as inputs to the rule's condition(s), and optionally (iii) one or more numeric fields that can be used to set thresholds for the rule's condition(s) if applicable. In some cases, the rules can each include a “format string” used to translate the programmatic logic (e.g., conditional logic) of the respective rule into a natural language description (e.g., provided by a user interface 150). The format string can enable the control insights system 100 to provide an indication to a user (e.g., in a natural language description) as to why a particular control insight was found to be applicable to an entity, without requiring the user to have to interpret the nuances of programmatic computer code.

In some embodiments, the rule definition module 130 may operate based on any suitable number of rule types (e.g., types of conditional statements). Some non-limiting examples of rule types can include:
Any of—if any of the list of indicators configured in the rule is observed in the time period (e.g., current month), the rule's control insight will be applicable to the entity;
All of—if all of the list of indicators configured in the rule is observed in the time period (e.g., current month), the rule's control insight will be applicable to the entity;
Any of threshold above—if the ratio of events with indicators of a first configured list of indicators by the events with indicators of the second configured list of indicators is above a configured threshold (e.g., threshold value), the rule's control insight will be applicable to the entity;
Any of threshold below—if the ratio of events with indicators of the first configured list of indicators by the events with indicators of the second configured list of indicators is below the configured threshold, the rule's control insight will be applicable; and
Any of duration—if any of the list of indicators configured in the rule is observed in the time period (e.g., current month), and it has been observed during a second time period (e.g., the past number of months) configured in the rule, the rule's control insight will be applicable to the entity.

In some embodiments, the rule definition module 130 may include and/or access rules that are a function of the control insights system 100 and each of the entities evaluated by the control insights system 100. For example, while the above-described exemplary rule types expect explicit values of indicators in order to determine whether a rule is satisfied, a relative value could be defined and used for comparison that is based on an aggregation of each entity's indicators. For example, a rule may be defined such that for a particular entity, “the number of events with indicators of a first configured list of indicators is no more than 20% away from the median of all entities evaluated via the control insights system 100.” This adaptation for relative rules that compare indicators between entities can allow for a more extensible rule set depending on the circumstance.

In some embodiments, a number of components can be used to define rules in order to derive dynamic or static threshold values based on external reference datasets. Use of the components to define rules can allow for a more accurate conclusion based on the indicators and the one or more datasets. For example, an individual may want to define the presence of a control insight as a function of another reference event indicated by the one or more datasets, such as a breach, presence of a particular malware family, vulnerability, etc. In some cases, a machine learning model could consume a particular reference dataset and a defined set of indicators that relate to a particular control insight to understand the optimal threshold, number, value, and/or other conditional metric for the control insight to apply to particular data. The machine learning model could updated continuously, such as when richer reference datasets are generated, when more entities are being evaluated, when different event types are added, and/or at discrete intervals. Table 1 as described below provides exemplary control insights mapped to respective rules, where satisfaction of a rule for a particular dataset indicates that the control insight applies to the dataset and the entity corresponding to the dataset.

TABLE 1
Exemplary Mappings of Control Insights to Rules

| Control Insight | Rule description |
|---|---|
| The ratio of malware infections | The ratio of infected systems by the |
| suggests the entity is appropriately | number of web browsers that are |
| protecting against malware threats | detected is below N % |
| The ratio of the vulnerabilities | The ratio between vulnerabilities |
| present for more than one month | present for more than one month and |
| suggests a weak vulnerability | the number of open ports is above |
| management process | N % |
| The use of Peer-to-Peer (P2P) | P2P software observed from the |
| software from the network suggests | network; |
| a weak control over software | |
| installed on entity-related | |
| workstations | |
| The presence of multiple Potentially | The ratio between PUP detections and |
| Unwanted Program (PUP) software | Browser detections is over N % |
| installations suggests a weak control | |
| over installed software and a weak | |
| user awareness; | |

As referred to in Table 1, “N %” may refer to any suitable percentage (e.g., a percentage ranging from 0%-100% or greater) In some embodiments, user of the control insights system 100 (e.g., cybersecurity experts) may define rules, control insights, and/or indicators for use by the control insights system 100 via a user interface 150 as described herein. The user interface 150 may enable configuration of a rule via a rule type, indicators provided as inputs to the rule, and/or numeric threshold value(s) for the rule. The individuals that define rules of the control insights system 100 via the rule definition module 130 may need to be familiar with the relationship between indicators and the conclusion corresponding to each indicator or combination of indicators. These individuals may include individuals corresponding to a service provider and/or an entity (e.g., customer entity) to which the service provider provides use of the control insights system 100. In some cases, customer entities of the service provider may be well-informed enough about each possible indicator in the control insights system 100 such that they may define rules and/or control insights for use by themselves and/or other customer entities of the service provider. In some cases, users with domain knowledge corresponding to a particular entity may define rules that are specifically used for generating control insights for the entity. As an example, the rules may be defined by a user providing one or more inputs to the user interface 150 to define a rule type, indicators, and/or threshold values for a rule based on a size of the entity (e.g., by employee count, revenue, market capitalization, etc.), geographic location in which the entity operates, cybersecurity posture of the entity, and/or organizational maturity of the entity.

### System Operation

In some embodiments, as described herein, the control insights system 100 may include a user interface 150 (e.g., a graphical user interface and/or a programmatic user interface) accessible via a computing device communicatively connected to the control insights system 100. In some cases, the user interface 150 may be referred to as a “management interface”. The user interface 150 may enable individuals to edit mappings defined by the control insights system 100. Some non-limiting examples of the mappings stored by the control insights systems 100 include mappings of:
events (and/or event types and subtypes) to indicators (e.g., events that are enriched with particular indicators);
indicators to rules (e.g., values of which indicators that rules receive as an input);
rules to control insights (e.g., rules that cause determination of one or more control insights based on a rule being satisfied);
control insights to cybersecurity controls of an entity (e.g., controls insights that are indicative of a state of particular cybersecurity controls; and
control insights to recommendations (e.g., control insights mapped to recommendations configured to improve a state of cybersecurity controls).

In some cases, the mappings stored by the control insights system 100 may be stored as data tables. In some cases, each of the mappings may, for example, be implemented in a structured flat file (e.g., a YAML file), which a data processing engine (not shown) of the control insights system 100 reads in order to build the associations between the individual components of the mappings and transform (e.g., enrich) the one or more datasets accordingly. Alternatively, each mapping could be implemented as a rule engine that is defined as computer-readable code rather than a separate definition. Any implementation of the mappings described herein may allow for users of varying levels of experience to modify the mappings and apply the mappings universally and/or to a specific set of customer entities or reports generated by the control insights system 100. In some cases, other benefits such as version control may be used by the control insights system 100 in order to provide a better means to reference historical states of mappings and support a means of backwards compatibility for mappings. In some cases, a mapping implementation is used that is able to scale to generate reports for millions of entities using the fewest possible resources.

In some embodiments, based on the mappings of the control insights system 100, an user of the control insights system 100 (e.g., information security expert) can translate events indicated by the one or more datasets into control insights. As described herein, control insights can provide relevant information about individual cybersecurity controls of an entity and can be extrapolated to provide an assessment of the operation of the cybersecurity control (e.g., to conclude whether the cybersecurity controls are operating successfully or failing). The mappings as described herein may be updated as new event types are added to the data collection module 110, as rules and insights are improved and/or otherwise modified, and/or as new controls are added to the list of controls (e.g., from a different control framework) that are supported and used by the control insights system 100 to generate control insights.

In some embodiments, the control insights system 100 may support any suitable number of formal and informal control and maturity model frameworks and the control insights system 100 may operate agnostic to any particular control and maturity model framework. In order to support more than one framework, the mapping between control insights and cybersecurity controls and recommendations are required to be added into the control insights system 100 (e.g., automatically based on a control framework or manually via interaction with the user interface 150) and the associated perceptions can be automatically derived by the control insights system 100 when all the applicable rules are evaluated based on their mappings to indicators. The control insights systems 100 may organize (e.g., categorize) generated results based on control and maturity model framework and allow a user to switch between different control frameworks.

In some embodiments, as described herein, control insights may provide a qualitative assessment of an entity's cybersecurity controls. For example, a control insight can have a positive, neutral, or negative nature to provide a positive, neutral, or negative assessment of a particular cybersecurity control of an entity. If a control insight has a negative nature, it may provide a negative assessment about a cybersecurity practice. If a control insight has a positive nature, it may provide a positive assessment about a cybersecurity practice. If a control insight has a neutral nature, it may provide contextual information for a cybersecurity control. In some cases, the control insights system 100 may determine a perception for a cybersecurity control based on one or more generated control insights associated with a particular cybersecurity control. The control insights system 100 may use one or more evaluation models to determine a perception for a cybersecurity control. An exemplary evaluation model may provide, after analyzing each control insights' applicability to a cybersecurity control, a result in the form of a perception of the state of the cybersecurity control according to the following criteria:
If at least 1 negative control insight was observed as corresponding to the cybersecurity control, the perception for the cybersecurity control is negative;
If only positive and optionally neutral control insights were observed as corresponding to the cybersecurity control, the perception for the cybersecurity control is positive;
If no control insights or only neutral control insights were observed as corresponding to the cybersecurity control, there is no perception for the cybersecurity control.

In some embodiments, control insights may be mapped to a questionnaire (e.g., available at and presented via the user interface 150), such that responses to the questionnaire are provided as inputs to rules to determine control insights. In some cases, responses to questions included in a questionnaire (e.g., made available for completion via the user interface 150) may be included in the one or more event datasets and may be provided as inputs to rules mapped to control insights. In some cases, the responses may be enriched with additional indicators as described herein.

In some embodiments, machine learning models may be included in and/or used by the control insights system 100 to map control insights to a questionnaires, such that particular questions included in a questionnaire can be used to determine control insights for particular cybersecurity controls. The machine learning model may be trained using a predetermined training dataset and/or using observations of users' mappings of control insights to questions and/or questionnaires. A questionnaire may be completed by an entity (e.g., by a representative or user of the entity) to understand the entity's cybersecurity practices. Completed questionnaires can be exchanged (e.g., sent and received) between entities via the control insights system 100 to understand each other's cybersecurity practices. For example, completed questionnaires may be exchanged between entities in a vendor risk management context. Control insights can be mapped to questions and/or responses within a questionnaire to provide a perception of an effectiveness of cybersecurity practice(s) corresponding to and/or associated with a question. In some cases, individuals corresponding to entities (e.g., risk managers) may compare responses provided by an affiliate of each of the entities. The individuals may review control insights and/or perceptions provided by the control insights system 100 that are mapped to questions in the questionnaire and may review discrepancies between the questionnaire and/or the derived control insights and/or perceptions corresponding to the affiliate. Such a comparison may enable remediation of one or more cybersecurity controls of the affiliate that have discrepancies between questionnaire responses and control insights and/or perceptions.

In some embodiments, the control insights system 100 can evaluate a current state of the entity's cybersecurity efficacy and performance as it relates to practices defined in various community-defined and customer-defined frameworks. Given the difficulty for an entity to adjust its cybersecurity practices in a short period of time, the control insights system 100 may not track a time series for an event over time and may operate using discrete time periods for evaluation purposes.

Based on the time required for an entity to modify and/or otherwise adjust cybersecurity practices, the control insights system 100 may produce perceptions of cybersecurity controls for an entity on a periodic (e.g., daily, weekly, monthly, etc.) basis and may interpret indicators observed during a particular time period (e.g., periodic time period). As an example, for a monthly basis configuration of the control insights system 100, a cybersecurity issue that is present in February 2023 may impact the cybersecurity control perception determined for the month of February 2023. When a cybersecurity control perception for March 2023 is determined, the event, the indicator, and the subsequent control insight may be re-observed and if the event (e.g., cybersecurity issue) is still present, it will be considered again to derive the perception. However, if the cybersecurity issue was addressed by the entity, it would not be re-observed during March, and thus that particular control insight may not again affect the perception of the cybersecurity control (e.g., unless another rule corresponding to the control insight is satisfied).

In some embodiments, the control insights system 100 may be configured to consider information derived from less or greater than a periodic time period (e.g., a monthly time period) and produce updated perceptions on a periodic basis. Such a configuration may use a rolling window of data (e.g., historical data) to produce updated perceptions. For example, the control insights system 100 may use the previous 3 months (or any other duration) of data when deriving a perceptions on a monthly basis. In some cases, the control insights system 100 can provide an “updated” perception for every cybersecurity control on a daily basis and can use a rolling window of 3 months (or any other duration) to determine the updated perception. The duration of the time period(s) used by the control insights system 100 to generate control insights and perceptions may be configurable via the user interface 150.

In some embodiments, as described herein, the control insights system 100 may include a user interface 150 that may provide an entity (and individuals associated with the entity) a report of a current perception of a state of their cybersecurity controls. In some cases, the report may be periodically updated. As an example, the report may provide the following:
The perception of each cybersecurity control is the aggregate result of each of the control insights observed in the past 6 months (or any other suitable duration of time); and
The perception of each control is the result of an analysis of the insight of each cybersecurity control for a one month (or any other suitable) time period, as follows: (i) if any of the insights are negative, the perception is negative; (ii) if there are only positive, or positive and neutral insights, the perception is positive; 3) if there are only neutral insights, the perception is neutral.

As described herein, a perception generated by the control insights system 100 may be incorrect. In some cases, a user can modify the perception of a cybersecurity control state and may provide evidence or a comment about the change of perception (e.g., via the user interface 150). In this case, the changed perception can show that it is a consequence of a user action.

In some embodiments, the user interface 150 may provide interactive components whereby a user may interact with the data collection module 110, the indicator mapping module 120, and/or the rule definition module 130. For example, via interaction with the user interface 150, a user of the control insights system 100 may modify data sources from which data is obtained by the data collection module 110, may generate and associate event types and subtypes with particular events by the indicator mapping module 120, and may define rules and related mappings of rules to control insights by the rule definition module 130.

In some embodiments, by the user interface 150, a user can select which cybersecurity controls of the an entity that are and are not monitored by the control insights system 100. For example, some smaller entities may not have capacity or funding to employ a program that would be expected to be employed by a larger organization. In some embodiments, by the user interface 150, a user can create a control framework monitoring by mapping an existing set of control insights to selectable cybersecurity controls, countermeasure, and/or sub-controls.

### Exemplary Method for Determining Control Insights

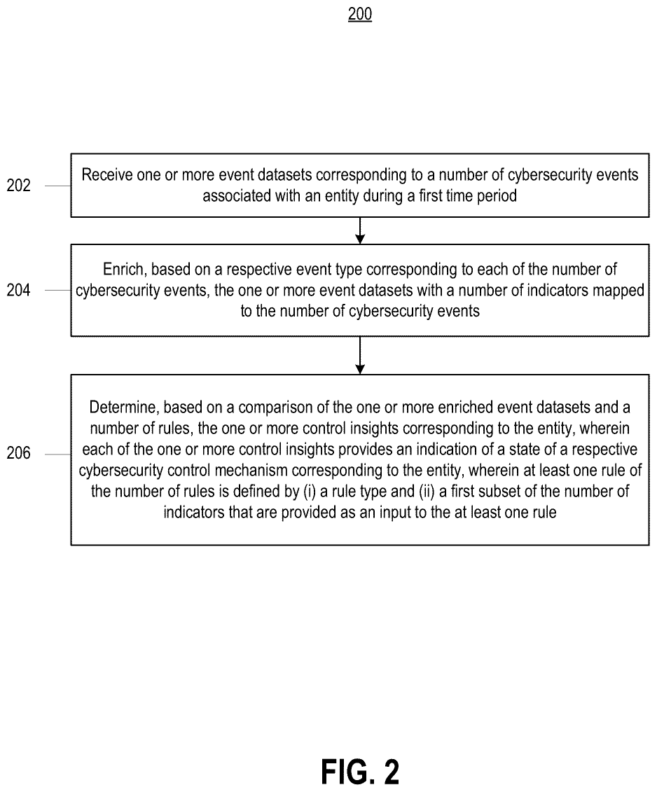

In some embodiments, the control insights system 100 may generate perceptions of cybersecurity control mechanisms corresponding to an entity. To generate the perceptions, the control insights system may perform a method for determining control insights for an entity. Results provided by the control insights system 100 may include one or more of control insights, perceptions, and actions (e.g., recommendations) corresponding to cybersecurity control mechanisms. Such results may be made available to entities via the user interface 150, a report, third-party computing systems (e.g., governance, risk and compliance (GRC) computing products), and/or any other suitable mechanism that enables individuals corresponding to entity to receive such results. Referring to FIG. 2, a flowchart of an exemplary method 200 for determining control insights is depicted. One of ordinary skill in the art will appreciate that the method 200 may be executed by the control insights system 100 more than once in parallel and/or serially to generate multiple reports including controls insights, perceptions, and/or recommendations derived from multiple datasets for multiple entities. The method 200 may further be executed by the control insights system 100 based on newly received events and/or at periodic intervals.

At step 202, the data collection module 110 may receive one or more event datasets corresponding to a number of cybersecurity events associated with an entity during a first time period. The number of cybersecurity events may be associated with one or more computing systems corresponding to the entity. The number of cybersecurity events may be derived from one or more of: malware sinkhole data, honeypot data, port scanning data, vulnerability scanning data, service configuration scanning data, actively and/or passively collected DNS data, advertising and marketing telemetry data, application-based endpoint behavior data, mobile application security assessment result data, DNS log data, authentication log data, netflow log data, web proxy log data, and firewall log data. The indicator mapping module 120 may determine a number of event types for the number of cybersecurity events, where each cybersecurity event is mapped to a respective event type of the number of event types that identifies the cybersecurity event.

At step 204, the indicator mapping module 120 may enrich, based on a respective event type corresponding to each of the number of cybersecurity events, the one or more event datasets with a number of indicators mapped to the number of cybersecurity events. Each cybersecurity event may be mapped to a respective subset (e.g., group) of the number of indicators including contextual information for the cybersecurity event. In some cases, the indicator mapping module 120 may enrich the one or more event datasets with the number of indicators based on (i) receiving, by the user interface 150, a user input including a selection of a second subset (e.g., group) of the number of indicators corresponding to at least one cybersecurity event of the number of cybersecurity events and (ii) enriching the at least one cybersecurity event with the second subset of the number of indicators. Such enrichment may allow a user to further supplement indicators mapped to particular cyber security events with their own contextual knowledge.

At step 206, the control insights system 100 (e.g., via the rule definition module 130) may determine, based on a comparison of the one or more enriched event datasets and a number of rules, the one or more control insights corresponding to the entity. Each of the one or more control insights can provide an indication of a state of a respective cybersecurity control mechanism corresponding to the entity. At least one rule of the number of rules may be defined by (i) a rule type and (ii) a first subset (e.g., group) of the number of indicators that is provided as an input to the at least one rule. Values for particular indicators may be provided as an input to a rule to determine whether particular the indicators (and related event(s)) satisfy the at least one rule, such that the a control insight either applies or does not apply to an entity's cybersecurity control mechanism. At least one control insight of the one or more control insights may include (i) a natural language description of the state of the respective cybersecurity control mechanism, and (ii) a categorical (e.g., positive, neutral, or negative) assessment of the state of the respective cybersecurity control mechanism. In some cases, the at least one rule of the number of rules can be further defined based on at least one characteristic corresponding to the entity and by (i) the rule type, (ii) the first subset of the number of indicators, and (iii) at least one threshold value.

In some embodiments, the number of rules can include a number of conditional statements as described herein. In some cases, the control insights system 100 may the determine the one or more control insights corresponding to the entity by (i) comparing the number of indicators of the one or more enriched event datasets to the number of rules, (ii) determining, based on the comparison of the number of indicators to the number of rules, the first subset of the number of indicators satisfying the at least one rule of the number of rules, and (iii) deriving, based on the first subset of the number of indicators satisfying the at least one rule, at least one control insight of the one or more control insights that is mapped to the at least one rule. In some cases, the at least one rule is further defined by at least one threshold value.

In some embodiments, the method 200 executed by the control insights system 100 can include one or more additional steps (not shown in FIG. 2). The control insights system 100 may (i) determine one or more values from the first subset of the number of indicators, (ii) compare, based on the rule type of the at least one rule, the one or more values to the at least one threshold value, and (iii) determine, based on the comparison of the one or more values to the at least one threshold value, the number of indicators satisfies the rule to derive the at least one control insight. The control insights system 100 may receive, by the user interface 150, a user input including a selection of the type and the first subset of the indicators for the at least one rule of the number of rules. In some cases, each of the number of cybersecurity events can include a timestamp indicative of a time at which the cybersecurity event was observed or otherwise recorded. The control insights system 100 may filter, based on the timestamps of the number of cybersecurity events, the one or more event datasets by removing, from the one or more event datasets, a subset (e.g., group) of the number of cybersecurity events including timestamps that are external to the first time period. In some cases, the one or more control insights can include two or more control insights, where the two or more control insights provide respective indications of the state of the same cybersecurity control mechanism. The control insights system 100 may determine, by an evaluation model and based on the two or more control insights, a perception of the cybersecurity control mechanism. The control insights system 100 may generate for display, based on the one or more control insights, an action (e.g., recommendation) that when executed (e.g., applied or performed) by the entity is configured to improve a state of at least one of the cybersecurity control mechanisms. The action may be mapped to a particular control insight as described herein and may be determined based on a control framework corresponding to the mapped control insight. As an example, the CIS20 control framework may identify cybersecurity safeguards that can be applied by an entity to their computing systems as being a function of the individual cybersecurity controls, such that the safeguards could be the most applicable recommendations determined and displayed by the control insights system 100 for a particular control insight.

Computer-based implementations

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

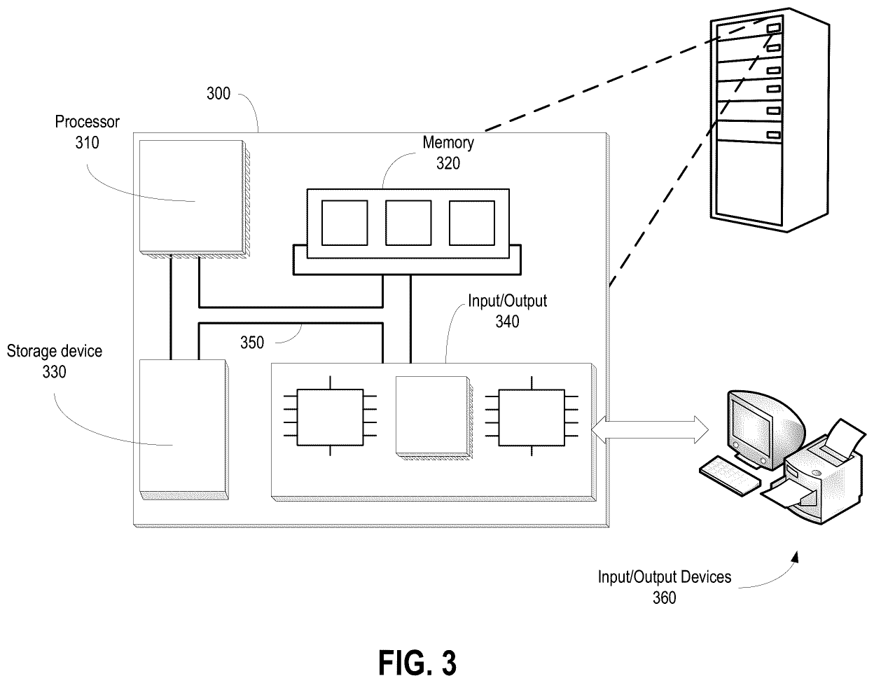

FIG. 3 is a block diagram of an example computer system 300 that may be used in implementing the technology described in this document. General-purpose computers, network appliances, mobile devices, or other electronic systems may also include at least portions of the system 300. The system 300 includes a processor 310, a memory 320, a storage device 330, and an input/output device 340. Each of the components 310, 320, 330, and 340 may be interconnected, for example, using a system bus 350. The processor 310 is capable of processing instructions for execution within the system 300. In some implementations, the processor 310 is a single-threaded processor. In some implementations, the processor 310 is a multi-threaded processor. The processor 310 is capable of processing instructions stored in the memory 320 or on the storage device 330.

The memory 320 stores information within the system 300. In some implementations, the memory 320 is a non-transitory computer-readable medium. In some implementations, the memory 320 is a volatile memory unit. In some implementations, the memory 320 is a non-volatile memory unit.

The storage device 330 is capable of providing mass storage for the system 300. In some implementations, the storage device 330 is a non-transitory computer-readable medium. In various different implementations, the storage device 330 may include, for example, a hard disk device, an optical disk device, a solid-date drive, a flash drive, or some other large capacity storage device. For example, the storage device may store long-term data (e.g., database data, file system data, etc.). The input/output device 340 provides input/output operations for the system 300. In some implementations, the input/output device 340 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 360. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 330 may be implemented in a distributed way over a network, such as a server farm or a set of widely distributed servers, or may be implemented in a single computing device.

Although an example processing system has been described in FIG. 3, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A computer-implemented method for determining one or more control insights corresponding to an entity, the method comprising:
receiving one or more event datasets corresponding to a plurality of cybersecurity events associated with an entity during a first time period;
enriching, based on a respective event type corresponding to each of the plurality of cybersecurity events, the one or more event datasets with a plurality of indicators mapped to the plurality of cybersecurity events; and
determining, based on a comparison of the one or more enriched event datasets and a plurality of rules, the one or more control insights corresponding to the entity, wherein each of the one or more control insights provides an indication of a state of a respective cybersecurity control mechanism corresponding to the entity, wherein at least one rule of the plurality of rules is defined by (i) a rule type and (ii) a first subset of the plurality of indicators that is provided as an input to the at least one rule.

2. The method of claim 1, wherein the plurality of cybersecurity events are associated with one or more computing systems corresponding to the entity and are derived from one or more of:
malware sinkhole data, honeypot data, port scanning data, vulnerability scanning data, service configuration scanning data, actively and/or passively collected domain name system (DNS) data, advertising and marketing telemetry data, application-based endpoint behavior data, mobile application security assessment result data, domain name system (DNS) log data, authentication log data, netflow log data, web proxy log data, and firewall log data.

3. The method of claim 1, further comprising:
determining a plurality of event types for the plurality of cybersecurity events, wherein each cybersecurity event is mapped to a respective event type of the plurality of event types that identifies the cybersecurity event.

4. The method of claim 1, wherein each cybersecurity event is mapped to a respective subset of the plurality of indicators comprising contextual information for the cybersecurity event.

5. The method of claim 1, wherein the enriching the one or more event datasets with the plurality of indicators further comprises:
receiving a user input comprising a selection of a second subset of the plurality of indicators corresponding to at least one cybersecurity event of the plurality of cybersecurity events; and
enriching the at least one cybersecurity event with the second subset of the plurality of indicators.

6. The method of claim 1, wherein at least one control insight of the one or more control insights comprises (i) a natural language description of the state of the respective cybersecurity control mechanism, and (ii) a positive, neutral, or negative assessment of the state of the respective cybersecurity control mechanism.

7. The method of claim 1, wherein at least one control insight is based on a control framework selected from the group consisting of: a Center for Internet Security Top 20 Critical Security Controls (CIS20) framework, a National Institute of Standards and Technology (NIST) framework, and an International Organization for Standardization and International Electrotechnical Commission (ISO/IEC) 27001 framework.

8. The method of claim 1, wherein the at least one rule of the plurality of rules is further defined based on at least one characteristic corresponding to the entity and by (i) the rule type, (ii) the first subset of the plurality of indicators, and (iii) at least one threshold value.

9. The method of claim 1, wherein the plurality of rules comprise a plurality of conditional statements, and wherein the determining the one or more control insights corresponding to the entity further comprises:
comparing the plurality of indicators of the one or more enriched event datasets to the plurality of rules;
determining, based on the comparison of the plurality of indicators to the plurality of rules, the first subset of the plurality of indicators satisfying the at least one rule of the plurality of rules; and
deriving, based on the first subset of the plurality of indicators satisfying the at least one rule, at least one control insight of the one or more control insights that is mapped to the at least one rule.

10. The method of claim 9, wherein the at least one rule is further defined by at least one threshold value, and further comprising:
determining one or more values from the first subset of the plurality of indicators;
comparing, based on the rule type of the at least one rule, the one or more values to the at least one threshold value; and
determining, based on the comparison of the one or more values to the at least one threshold value, the plurality of indicators satisfies the rule to derive the at least one control insight.

11. The method of claim 1, further comprising:
receiving a user input comprising a selection of the type and the first subset of the indicators for the at least one rule of the plurality of rules.

12. The method of claim 1, wherein each of the plurality of cybersecurity events comprises a respective timestamp indicative of a time at which the cybersecurity event was observed, and further comprising:
filtering, based on the timestamps of the plurality of cybersecurity events, the one or more event datasets by removing, from the one or more event datasets, a subset of the plurality of cybersecurity events comprising timestamps that are external to the first time period.

13. The method of claim 1, wherein the one or more control insights comprise two or more control insights, wherein the two or more control insights provide respective indications of the state of the same cybersecurity control mechanism, and further comprising:
determining, by an evaluation model and based on the two or more control insights, a perception of the cybersecurity control mechanism.

14. The method of claim 1, further comprising:
generating for display, based on the one or more control insights, an action that when executed by the entity is configured to improve a state of at least one of the cybersecurity control mechanisms, wherein the action is determined based on a control framework corresponding to the at least one of the cybersecurity control mechanisms.

15. A system for determining one or more control insights corresponding to an entity, the system comprising:
one or more computing systems programmed to perform operations comprising:
receiving one or more event datasets corresponding to a plurality of cybersecurity events associated with an entity during a first time period;
enriching, based on a respective event type corresponding to each of the plurality of cybersecurity events, the one or more event datasets with a plurality of indicators mapped to the plurality of cybersecurity events; and
determining, based on a comparison of the one or more enriched event datasets and a plurality of rules, the one or more control insights corresponding to the entity, wherein each of the one or more control insights provides an indication of a state of a respective cybersecurity control mechanism corresponding to the entity, wherein at least one rule of the plurality of rules is defined by (i) a rule type and (ii) a first subset of the plurality of indicators that is provided as an input to the at least one rule.

16. The system of claim 15, wherein the plurality of cybersecurity events are associated with one or more computing systems corresponding to the entity and are derived from one or more of: malware sinkhole data, honeypot data, port scanning data, vulnerability scanning data, service configuration scanning data, actively and/or passively collected domain name system (DNS) data, advertising and marketing telemetry data, application-based endpoint behavior data, mobile application security assessment result data, domain name system (DNS) log data, authentication log data, netflow log data, web proxy log data, and firewall log data.

17. The system of claim 15, wherein the operations further comprise:
determining a plurality of event types for the plurality of cybersecurity events, wherein each cybersecurity event is mapped to a respective event type of the plurality of event types that identifies the cybersecurity event.

18. The system of claim 15, wherein each cybersecurity event is mapped to a respective subset of the plurality of indicators comprising contextual information for the cybersecurity event.

19. The system of claim 15, wherein the enriching the one or more event datasets with the plurality of indicators further comprises:
receiving a user input comprising a selection of a second subset of the plurality of indicators corresponding to at least one cybersecurity event of the plurality of cybersecurity events; and
enriching the at least one cybersecurity event with the second subset of the plurality of indicators.

20. The system of claim 15, wherein at least one control insight of the one or more control insights comprises (i) a natural language description of the state of the respective cybersecurity control mechanism, and (ii) a positive, neutral, or negative assessment of the state of the respective cybersecurity control mechanism.
